(19) United States
(12) Patent Application Publication
(10) Pub. No.: US 2024/0411355 A1
(43) Pub. Date: Dec. 12, 2024

(54) SYSTEM, METHOD, AND/OR NON-TRANSITORY COMPUTER READABLE STORAGE MEDIUM FOR PROVIDING ENERGY MANAGEMENT FOR AT LEAST ONE SENSOR IN AN INTERNET OF THINGS (IOT) ENVIRONMENT

(71) Applicant: Cumulocity GmbH, Düsseldorf (DE)

(72) Inventors: Prakashgouda CHANNAGOUDRA, Bangalore (IN); Anireekshita Narayana, Bangalore (IN); Rinku Hazarika, Bangalore (IN)

(21) Appl. No.: 18/678,455

(22) Filed: May 30, 2024

(30) Foreign Application Priority Data
Jun. 6, 2023 (EP) EP23177649.3

(51) Int. Cl. G06F 1/3209; G16Y 40/40

(52) U.S. Cl. CPC G06F 1/3209; G16Y 40/40

(57) ABSTRACT

Certain example embodiments relate to Internet of Things (IoT) technology and, more particularly, to techniques for managing energy of at least one sensor. Sensor data resulting from a detection by the sensor(s) is detected. The sensor data includes sensor values specific to a characteristic to be detected by the sensor(s). The collected sensor data is evaluated. The evaluating includes generating an operating specification for the sensor(s) based on a detection of at least one deviation pattern in the sensor values of the collected sensor data that indicates a variation of the characteristic to be detected. The operating specification defines a future activity pattern for the detection by the sensor(s). At least one change of an operational setting for the detection by the sensor(s) is initiated, with the change being initiated based on the generated operating specification.

### CROSS-REFERENCE TO RELATED APPLICATION

This application claims priority to EP 23177649.3 filed on Jun. 6, 2023, the entire contents of which are hereby incorporated herein by reference.

### TECHNICAL FIELD

Certain example embodiments relate to internet of things (IoT) technology and, more particularly, to techniques for providing energy management for at least one sensor.

### BACKGROUND AND SUMMARY

It is known that various technological devices or “things” can be used for making life smarter, better, and easier. Many of these devices can be connected via the Internet and, thus, the “Internet of Things (IoT)” has already become part of everyday life for some. IoT may be used for monitoring and controlling devices.

Billions of devices and particularly sensors may be deployed in the field for acquiring a field information. These sensors typically run on a battery. Since batteries have a limited life, if a battery goes down, then the sensor may be useless and an IoT application may not provide the expected or required quality of service (QOS). It is therefore desirable to ensure that batteries are replaced or recharged appropriately. In a vast and potentially open field of sensors (for example, in a mountain area, in a hilly region, etc.), it may be a difficult task to find and replace a dead battery of a sensor. It is particularly a great challenge how to keep or save the energy of an IoT network for a longer duration, especially in scenarios where it can be difficult to replace the batteries.

It is known that models can be used to plan the states of the sensors to optimize the energy consumption. Such models may be forecasting models such as artificial intelligence (AI), artificial neural network (ANN), and support vector machines (SVM). Known models are oftentimes created based on the history of how applications call or read those sensors.

Unfortunately, however, there may be limitations with such models. For example, there may be two applications, one that reads temperature sensor data and serves to a user whenever the user requests for the current temperature data (application T), and another application may read humidity sensor data (application H). Person A may use application T every day in the morning, and person B may use application H every day at noon. Based on this data, models may predict the optimal states of these sensors, e.g., they may plan when the sensors should be active or inactive in a way that the energy consumption is optimized. A prediction model, which is designed based on how frequently the user used the application for viewing the temperature, may therefore predict when the sensor should be ON or OFF. However, if many people start using the application at different times, then the model may fail to predict a random (or seemingly random or even highly variable) request arrival and fail to offer better QoS.

U.S. Pat. No. 10,712,723 discloses an analysis of energy consumption of end appliances. Based on a consumption pattern, the platform may inform a user when their hourly consumption goes beyond the predefined budget. To achieve this, extra sensors may be necessary.

U.S. Pat. No. 10,433,270 discloses a saving controller (coordinator) battery with fixed configured time intervals based on usage time intervals and patterns for keeping devices ON/OFF. As it depends on fixed time intervals for deciding coordinator state, there may be no scope of improvement of the system performance even if there is a continuous flow of data into the system.

In U.S. Pat. No. 9,007,225, a decentralized system is described where logic is embedded in each sensor unit. This sensor unit may be kept in low-power mode and may be awakened on detecting anomalous condition. However, it may be restricted to operation on live data.

The discussed state-of-the-art documents are particularly designed for a specific domain and/or protocol. They may be less optimal in situations where a randomness or higher level of variation occurs in the system that influences the activity of the sensors. For example, some are particularly specific to certain domains like consumer appliances and focus around electricity consumption only. As this is specific to a certain domain, these solutions may not be capable of handling sensor data that uses different protocols to communicate.

One aspect of certain example embodiments relates to at least partially overcoming the above-described and/or other technical challenges. Certain example embodiments provide better energy management for sensors.

The disclosure contemplates a method, a system, a non-transitory computer readable storage medium storing a computer program, and a data processing apparatus. Further features and details are disclosed in the description below and in the drawings. Features and details described in the context of the method, the system, non-transitory computer readable storage medium storing the computer program, and/or data processing apparatus are applicable to each other in each case.

In certain example embodiments, a method for providing energy management for at least one sensor is provided. The method may particularly be a computer-implemented method.

The method of certain example embodiments may comprise collecting sensor data. The sensor data may result from a detection by the at least one sensor. Furthermore, the sensor data may comprise sensor values specific to a characteristic to be detected by the at least one sensor. For example, the characteristic to be detected may be a measurand that is measured by the at least one sensor. The sensor values therefore may quantify the measurand. The collection of the sensor data may comprise receiving the sensor data in the form of digital data, e.g., using a data stream and/or using a data network and/or over the internet and/or over a wireless network. To this end, a network interface may be used to receive the sensor data. The collection of the sensor data may further comprise a caching and/or non-volatile storage of the data, e.g., in a data memory.

Certain example embodiments may further comprise evaluating the collected sensor data. The evaluating may comprise generating, e.g., planning and/or predicting, an operating specification that indicates at least one or multiple optimal operating state(s) for the at least one sensor. The operating specification may be generated for the at least one sensor based on the sensor values of the collected sensor data, e.g., based on a detection of at least one deviation pattern in the sensor values of the collected sensor data that indicates a variation of the characteristic to be detected. In other words, the future operational states of the at least one sensor may be planned by an evaluation of the content of the collected sensor data, thereby predicting the states in form of optimal states for optimizing the energy consumption of the at least one sensor.

Certain example embodiments may comprise initiating at least one change of an operational setting for the detection by the at least one sensor. The change may be initiated based on the generated operating specification. For example, the state of the at least one sensor may thereby be set in accordance with the states planned in the operating specification. The initiating may be possible by sending a command and/or configuration data to the at least one sensor using a data interface, e.g., a network interface.

The sensor data may, in simple terms, represent or comprise sensor values of what is to be measured by the sensor, for example, a voltage of a battery. Therefore, the evaluation is not limited to “meta information” about the sensor measurements, for example, a time of transmission of the sensor data. In said example, a characteristic to be detected would be the voltage of the battery. The operating specification may, in simple terms, describe how the operational setting for the detection is to be changed, for example, in relation to a date and time or as a function of at least one and/or different features of the sensor data, for example, the at least one deviation pattern. The generating of the operating specification may comprise or be performed as a prediction since it provides an assumption of the future operational states of the at least one sensor. The generating of the operating specification may be performed by a computer-implemented algorithm and/or by a prediction model like a rule-based engine (EMS). The algorithm may be designed to minimize energy consumption by means of providing optimal future operational settings for the detection by the at least one sensor based on historical sensor data. The operating specification may be advantageous to, for example, optimize a duration and/or a time and date of when the at least one sensor is carrying out the detection so that the energy consumption by the sensor may be optimized, and for example minimized.

It is possible that the generating is based on the detection of the at least one deviation pattern in the sensor values of the collected sensor data, with (for example) the sensor values being measured values such as measured physical values, which represent a quantification of the characteristic to be detected, the characteristic potentially being a measurand. The operating specification may define a future activity pattern for the detection by the at least one sensor, e.g., comprising future operational states for the at least one sensor. A simple example for the above may be that a sensor is measuring a temperature, which would be a characteristic to be detected, wherein one exemplary sensor value may be 20° C. An exemplary deviation pattern in this particular example may reveal that the temperature on Mondays is roughly constant between 7 AM and 11 AM and rises significantly between 11 AM and 12 PM.

It may be provided that the generating of the operating specification for the at least one sensor is further based on at least one of the following:
a detection time indicating a time of detection or transmission of the sensor values by the least one sensor,
a change time indicating a time of change of the sensor values, and
a deviation indicator for the sensor values, particularly based on a standard deviation of a series of the sensor values.

The change time may indicate a specific time, for example “1:43 PM”, or it may indicate a time frame, for example “between 1 PM and 2 PM” or “Tuesday”. The deviation indicator may quantify a specific deviation in the sensor values or in a series of the sensor values, e.g., quantified by means of the respective standard deviation. An example may be that the standard deviation of the sensor values between 1 PM and 2 PM is 0.4. The above factors may further help to optimize the time of when the at least one sensor is carrying out the detection so that the energy consumption may be minimized.

It may be advantageous that the evaluating comprises applying at least one rule based on the sensor values of the collected sensor data, e.g., using a rule-based engine. The initiating of the change of the operational setting may be carried out based on the applied at least one rule. The at least one rule may comprise at least one of the following rules:
Applying a procedure to derive a standard deviation to detect the at least one deviation pattern in the collected sensor data of the at least one sensor and deciding on the operating specification based on the procedure to derive the standard deviation.
Applying at least one external environmental monitoring system, e.g., to predict external changes of an environment of the at least one sensor, and deciding on the operating specification based on an output of the at least one external environmental monitoring system.

Applying the at least one rule may be an application of at least one “if-then” statement and may be implemented in the form of an algorithm performed by a computing system. A simple example for a rule may be that the initiating of the change of the operational setting is carried out if a sensor value is above a defined threshold. Applying the at least one rule may bring about the advantage that specific conditions may be set out by the rules to further optimize a timing of the initiating of the change of the operational setting and thereby decrease the energy consumption.

Furthermore, the application of the at least one rule may be carried out using a decision tree. The decision tree is an algorithm that relies on rule-based logic. It may utilize a hierarchical structure of decision rules to analyze the sensor data. Some example variants of the decision tree algorithm include the ID3, C4.5, and CART algorithms. The rule-based engine may therefore also be configured as or may be part of a prediction model.

Certain example embodiments may further comprise:
receiving a flag for the at least one sensor, the flag being specific to a sensor type of the at least one sensor and, for example, comprising at least the following types: a temperature sensor, humidity sensor, motion sensor, proximity sensor, light sensor, accelerometer, pressure sensor, gas sensor, GPS sensor, and/or moisture sensor, and
carrying out the initiating of the at least one change of the operational setting based on the received flag, thereby enabling the energy management and/or the application of the rules based on the received flag.

The flag may be set, deleted or checked. The flag may be represented as a Boolean variable, wherein a value of 1 may indicate that the flag is set. Providing the flag may bring about the advantage that the initiating of the at least one change of the operational setting may be carried out specifically as a function of the sensor type of the at least one sensor. It is possible that the flag is only set for certain types of sensors so that the energy management is only enabled for these types of sensors.

It is further conceivable that a continuous learning and optimization of the generating of the operating specification and of the detection of the at least one deviation pattern is carried out, the continuous learning and optimization comprising periodically updating the generated operating specification based on further collected sensor data of the at least one sensor, the continuous learning and optimization comprising:
collecting further sensor data of the at least one sensor, and
carrying out the evaluating of the further collected sensor data, thereby amending or replacing the operating specification based on the sensor values of the further collected sensor data.

The continuous learning and optimization of the generating of the operating specification may provide the advantage of overall better energy saving, e.g., because the at least one change of the operational setting may be initiated more frequently. Furthermore, a prediction model may be applied. It will be appreciated that the prediction model may rely on technologies other than machine learning. For example, the prediction model can be configured as a rule-based engine (EMS) and/or expert system. The continuous learning may comprise incrementally updating and improving the prediction model's performance over time as new sensor data becomes available. It may involve adapting the prediction model's parameters or structure to incorporate new information while preserving previously learned knowledge. For example, a feedback loop may iteratively refine and adjust the prediction model based on the evaluation of its performance on the new sensor data, ensuring ongoing improvement and adaptation. Further possibilities for implementing a continuous learning may be the usage of rule induction techniques to automatically generate new rules from new data.

In certain example embodiments, the operating specification may specify a pattern of the at least one change of the operational setting, comprising a sequence of changes of the operational setting over time, e.g., comprising different operational settings and/or states of the operation of the at least one sensor over time.

Further, it may be provided that the operational settings include at least one of the following settings, which may be (operational) states:
a sleep state in which a receiving of commands of the at least one sensor is enabled and a transmission of the sensor data from the at least one sensor is disabled, the initiating the at least one change of the operational setting being carried out by sending at least one of the commands to the at least one sensor,
an awake state in which the receiving of commands and the transmission of the sensor data from the at least one sensor is enabled, and
a rate at which the detection by the at least one sensor takes place, e.g., at which sensor values are collected.

Furthermore, the at least one sensor may be initially in the awake state for a defined timeframe to provide the collected sensor data for the evaluating. Each of the above settings may have an advantage with regard to a specific time and date and/or a specific environmental condition. Providing a variety of the above settings may allow for an advantageous diversification so that the energy consumption may be minimized by utilizing an appropriate setting for a specific time and date and/or for a specific environmental condition.

In an example embodiment, the method may further comprise:
calculating a mean and a standard deviation of the collected sensor data over a defined time period, and
generating the operating specification for the at least one sensor based on the calculated mean and standard deviation of the collected sensor data.

The defined time period is for example one hour or one day and may advantageously be varied according to specific requirements and a specific environment of the at least one sensor.

It may be provided that the generating of the operating specification is further based on an external environmental monitoring, the external environmental monitoring being performed by an external prediction model for example. The external environmental monitoring may be designed to predict weather or rain in particular, and thus may be a weather or rain forecasting model. The external environmental monitoring could be any existing system used to predict environmental changes for example, rain, pressure, humidity, etc.

It is also possible that the generating of the operating specification is further based on an external user access monitoring. The external environmental monitoring may comprise measuring environmental parameters, for example, a temperature or an atmospheric pressure. The external environmental monitoring may be advantageous, because an influence of the environment on the energy consumption of the battery may then be taken into account to further minimize energy consumption. The external user access monitoring may track a number of users accessing the sensor so that the operational setting may advantageously be set accordingly when a certain number of users accesses the sensor. If a large number of users accesses the application, then there may be an increase in sensor readings and a greater variation in the sensor reading values. However, in certain example embodiments, there may be no direct correlation between some operational settings (for example On/Off/Sleep) and the number of users. In other words, the number of users accessing the system for sensor data may have no impact on the decision-making process for generating the operational settings, and for instance, whether to change the sensor to On, Off or Sleep mode, in at least some scenarios. The system may be a central system which is connected to the sensors and is configured to control the state of the sensors based on the deviation pattern. With more data, which increases the sensor data points over time, the prediction of the system can become more accurate.

In certain example embodiments, the method may further comprise monitoring a battery of the at least one sensor, thereby indicating a low battery status of the battery, the low battery status potentially being alerted to a user and/or the generating of the operating specification being based on the indicated low battery status.

The monitoring may be performed by periodically measuring at least one parameter of the battery, for example, a voltage. The low battery status may be indicated at a defined level of said at least one parameter, for example, if the current measurement indicates a value of a tenth of a maximum value of the at least one parameter of the battery. By means of the monitoring of the battery, it may advantageously be provided that if the low battery status is indicated, the at least one change of the operational setting for the detection by the at least one sensor is initiated more frequently to save energy.

Certain example embodiments further comprise changing the operational setting for the detection of the at least one sensor based on at least one trigger, the at least one trigger comprising at least a signal indicating an external event, e.g., a user input, and/or a time event and/or a specific deviation pattern and/or a specific timepoint of a low battery status of the at least one sensor. The specific deviation pattern may be a significantly high or low value or a same value for a certain time span in the sensor data. Providing the at least one trigger may further diversify how and when the operational setting for the detection of the at least one sensor may be changed so that the saving of energy may be further optimized.

Another aspect of certain example embodiments relates to a system for providing energy management of at least one sensor, comprising at least:
a data collection unit for collecting sensor data, the sensor data resulting from a detection by the at least one sensor, the sensor data comprising sensor values specific to a characteristic to be detected by the at least one sensor,
an evaluation unit for evaluating the collected sensor data, the evaluating comprising generating an operating specification for the at least one sensor based on the sensor values of the collected sensor data, e.g., based on a detection of at least one deviation pattern in the sensor values of the collected sensor data that indicates a variation of the characteristic to be detected, and
a control unit for initiating at least one change of an operational setting for the detection by the at least one sensor, the change being initiated based on the generated operating specification.

Thus, a system according to certain example embodiments has the same advantages as have been described in detail with reference to the method summarized above. Furthermore, the system may be domain-agnostic, i.e., not be specific to any particular domain, like consumer appliances, and/or it may be applicable to multiple of different sensor types as well as different kinds of protocols that they use for communication.

A system according to certain example embodiments may be configured as a centralized platform, wherein the at least one sensor may be connected to the system to have the at least one sensor monitored for energy saving. It may thus be provided that an extension of the system with further sensors is possible, the sensors being selected according to different functional requirements or environments. It is further possible that at least one sensor is integrated into the centralized platform, i.e. the system.

In another aspect, a non-transitory computer readable storage medium tangibly storing a computer program may be provided. The program may be a computer program product, comprising instructions which, when the computer program is executed by a computer, cause the computer to carry out a method described herein. Thus, the non-transitory computer readable storage medium and/or computer program according to certain example embodiments may have the same advantages as have been described in detail with reference to a method discussed herein.

The computer may be a data processing device which executes the computer program. The computer may include at least one processor that can be used to execute the computer program. Also, a non-volatile data memory may be provided in which the computer program may be stored and from which the computer program may be read by the processor for being carried out.

According to another aspect, a data processing apparatus may be provided. The apparatus may comprise the computer program disclosed herein. The data processing apparatus may be a computer and may comprise a data storage device such as a hard disk and/or a non-volatile memory and/or a memory card and/or a solid-state drive. The storage medium may, for example, be integrated into the computer.

Furthermore, the methods disclosed herein may be implemented as computer-implemented methods.

Further advantages, features, and details of the invention will be apparent from the following description, in which certain example embodiments of the invention are described in detail with reference to the drawings. In this connection, the features mentioned in this disclosure may be used individually or in any combination.

### BRIEF DESCRIPTION OF THE DRAWINGS

FIG. 1 is a schematic drawing of a method, computer program, and data processing apparatus according to certain example embodiments;

FIG. 2 is a schematic drawing of a system according to certain example embodiments;

FIG. 3 is a schematic drawing of an energy efficiency model according to certain example embodiments; and

FIG. 4 is a flowchart for an Energy Management System in accordance with certain example embodiments.

### DETAILED DESCRIPTION

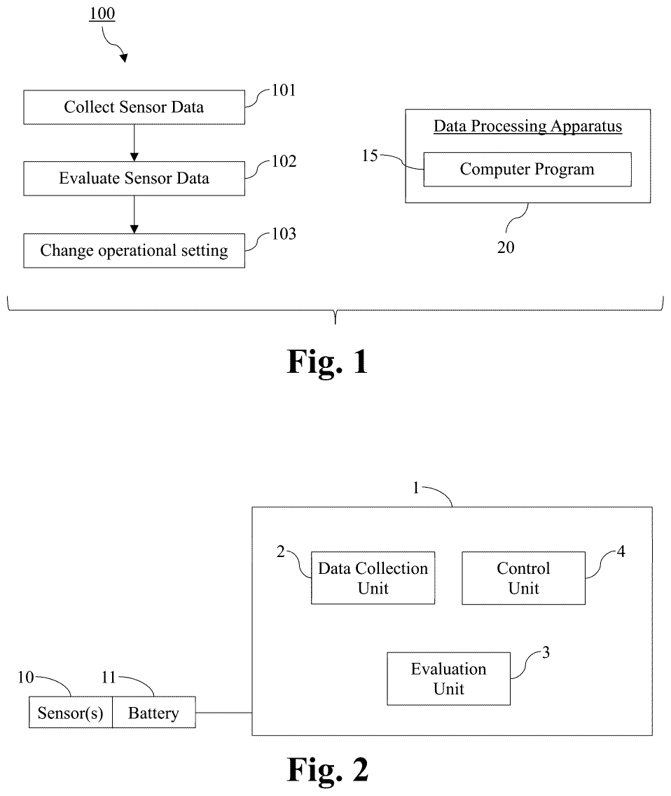

FIG. 1 shows a method 100, a data processing apparatus 20, and a computer program 15 according to certain example embodiments. The computer program 15 may be implemented on the data processing apparatus 20, for example, in the form of a computer server or local personal computer. In certain example embodiments, the computer program 15 may be executed on the data processing apparatus 20 comprising a processor (e.g., a central processing unit (CPU)), memory, and input/output devices. The computer program 15, stored in the memory, may include a set of instructions that, when executed by the processor, enables the data processing apparatus 20 to perform specific operations and functions. The hardware components of the data processing apparatus 20 may be designed to facilitate efficient execution of the computer program 15, with the processor processing the instructions, the memory storing and retrieving data, and the input/output devices facilitating communication with external systems or user interactions. The computer program 15 may interact with the hardware through interfaces and protocols. Furthermore, the data processing apparatus 20 may comprise a data interface for receiving external data that thereby can be provided to the processing according to the computer program 15. The processor of the data processing apparatus 20 may be configured as one or more of the following, for example: central processing unit (CPU), graphics processing unit (GPU), field-programmable gate array (FPGA), digital signal processor (DSP), application-specific integrated circuit (ASIC), reduced instruction set computing (RISC), complex instruction set computing (CISC), very long instruction word (VLIW), etc.

The method 100 according to certain embodiments comprises collecting sensor data (step 101). The sensor data may result from a detection by the at least one sensor 10 (described further in connection with FIG. 2). The sensor data may comprise sensor values specific to a characteristic to be detected by the at least one sensor 10. In step 102, the collected sensor data may be evaluated. The evaluating may comprise generating an operating specification for the at least one sensor 10 based on the sensor values of the collected sensor data, e.g., based on a detection of at least one deviation pattern in the sensor values of the collected sensor data that indicates a variation of the characteristic to be detected. In step 103, at least one change of an operational setting for the detection by the at least one sensor 10 may be initiated. The change may be initiated based on the generated operating specification.

Advantageously, certain embodiments may thereby support a randomness or potentially large-scale deviations that could occur in the system and/or may support continuous learning. Randomness may result from a random nature or factors that can come from external users or environments. For example, a large number of people may start using the application or there could be a sudden change in the environment temperature and/or humidity, etc.

FIG. 2 shows a system 1 according to certain example embodiments. The system 1 comprises a data collection unit 2 for collecting sensor data. The sensor data may result from a detection by the at least one sensor 10. The sensor data may comprise sensor values specific to a characteristic to be detected by the at least one sensor 10. The system 1 according to the preferred embodiment further comprises an evaluation unit 3 for evaluating the collected sensor data. The evaluating may comprise generating an operating specification for the at least one sensor 10 based on the sensor values of the collected sensor data, e.g., based on a detection of at least one deviation pattern in the sensor values of the collected sensor data that indicates a variation of the characteristic to be detected. The system may also comprise a control unit 4 for initiating at least one change of an operational setting for the detection by the at least one sensor 10, the change being initiated based on the generated operating specification.

The system according to certain example embodiments is in connection with at least one sensor 10. The at least one sensor 10 may also be integrated into the system 1. The data collection unit 2 may comprise or be embodied as means for carrying out the collecting of the sensor data. The data collection unit 2 may comprise a data interface and/or a data memory for receiving and/or storing the received sensor data. The evaluation unit 3 may comprise or be embodied as means for carrying out the evaluating of the collected sensor data. The evaluation unit 3 may comprise at least one processor and/or may be embodied as a microprocessor or microcomputer. The control unit 4 may comprise or be embodied as means for carrying out the initiating of the at least one change of an operational setting for the detection by the at least one sensor 10. The control unit 4 may comprise an output for sending a command and/or settings to the at least one sensor. The control unit 4 may comprise a hardware interface and/or network interface for sending the command and/or settings to the at least one sensor.

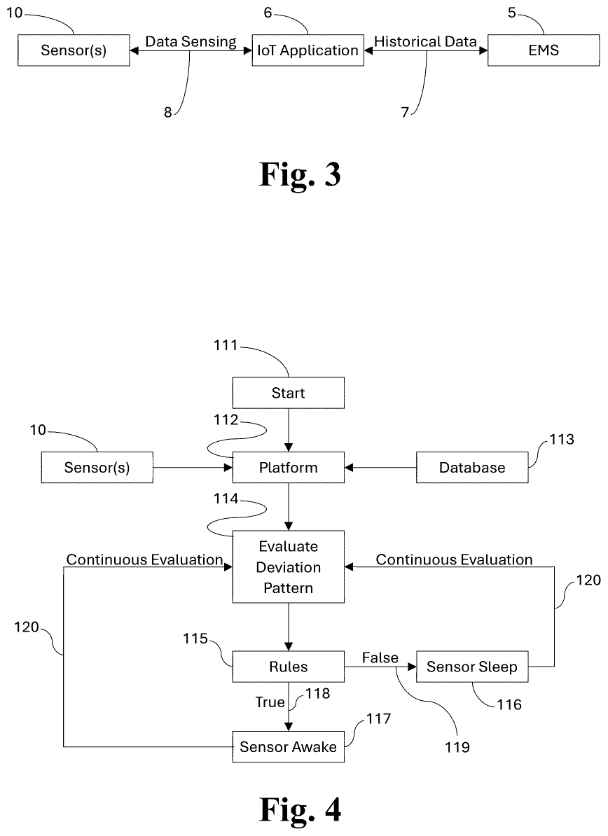

FIG. 3 shows an example embodiment of an energy efficiency model system (EMS) 5 that can be deployed in an IoT application 6 in accordance with certain example embodiments. The IoT application may read out 8 sensor data from at least one sensor 10. The system according to certain example embodiments may be capable of efficiently scheduling AWAKE and/or SLEEP states of sensors 10 to save the power to a larger extent in the long term and having satisfied QoS.

Certain example embodiments may provide an energy management of the sensors 10 that considers how the readings of the sensors 10 changed in the past. Therefore, the energy management may concern the sensors 10 but not the applications 6 that read out sensor data (see FIG. 3, data sensing 8). As part of the energy management system, a prediction model may be used to control the states of the sensors 10, e.g., to turn the sensor 10 ON when it must be turned on and to turn the sensor 10 to SLEEP during other time. A prediction model may be trained with historical data 7 of the sensors 10. The historical data 7 may be specific for, for example: when the sensors 10 sent the readings, when these readings changed, how much is the standard deviation of the current reading from the previous reading, an effect of external conditions like cyclone/thunderstorm/earthquake, etc. The system according to certain example embodiments may be configured to update the prediction model as and when there is a change. The prediction model may comprise a combination of time series forecasting and weather forecasting. It may also be made use of existing weather forecast models in another example embodiment.

The prediction model may comprise a rule-based engine (EMS). This rule-based system may constantly evaluate a deviation pattern with the help of historical sensor data on which it may decide when sensor 10 should be awake/sleep.

The rule-based engine may carry out its decisions based on at least one of the following rules:
Rule 1 may be: Apply a procedure to derive a standard deviation, e.g., based on standard deviation theory to detect deviation in the readings and decide on sensor state.
Rule 2 may be: Use of at least one external environmental monitoring system, e.g., in the form of an (existing) model, to predict external changes and decide on sensor state.

The more historical data 7 that is available, the more accurate the deviation pattern may be. Hence, with time, the system may be more matured. The system can be enhanced and may be integrated into a prediction model, for example, in an Arima model.

A system according to certain example embodiments may also use already existing models. Some of these existing models may be also used in EMS for handling environmental changes. There may be systems already there for predicting temperature changes, pressure changes, etc. Certain example embodiments make use of these already existing systems in the EMS for better decision making when environmental and/or external changes are predicted. In certain example embodiments, one may configure the external models that should be used in EMS. If, for example, the system according to certain embodiments is configured to use external models such as a “rain prediction model”, then EMS may consider the prediction output of this model to override rule 1 (standard deviation rule) output. The prediction output may be one of, but not limited to, the following. It may be an indication in a weather prediction app, for example an app that predicts rain between 15:00 to 16:00 on a certain day. It may be a single value, e.g., an output of a sensor within the system (a humidity prediction sensor indicating a change in humidity). The user may configure the system to perform energy management based only on a standard deviation or as a combination of a standard deviation and an external environmental monitoring system. In case the user opts for the latter, the user may have to configure the system to indicate the different external sensor/app outputs to be considered for the EMS (this could be more than one). That is, the user may decide to consider the output of a weather prediction app and another sensor within the system to be used for the EMS in combination with a calculation of a standard deviation. An advantage of using an external environmental monitoring system is the ability to improve the accuracy of the system. This can help ensure that the EMS does not miss out on any sensor readings when an environmental change takes place. Reference is made to FIG. 4 showing a flowchart and the pseudocode discussed hereinbelow. The EMS may then decide the state of the sensor 10. The platform of certain example embodiments may be configured to use an EMS output of one sensor 10 in another sensor 10.

According to certain example embodiments, a system may use historical sensor readings. The system may also be referred to as or comprise a platform for energy management of at least one sensor 10. The platform may have a flag to enable EMS for a particular sensor type. Thus, through this platform, one can control whether EMS should be enabled and/or disabled for a particular type of sensor 10. The EMS enabled for one sensor may be independent of the EMS enabled for another sensor 10. However, it may be possible that the system is configured so that a user can configure to use an EMS engine output of one sensor 10 in another EMS engine configured for another sensor 10.

The system according to certain example embodiments can predict dynamic changes and act accordingly on sensors 10 to save their energy.

In the following text, some real-world examples where certain example embodiments can be applied are discussed.
Oceanography example: Moorings are stationary instruments anchored to the seafloor that measure various oceanographic parameters like temperature, salinity, and currents. Whenever the parameters are static, one can turn certain sensors 10 on and off, and only the necessary sensors 10 may be active at any given time, conserving power and prolonging the life of the mooring system. This can be useful in long-term monitoring studies where a mooring may need to operate for several years in a remote location.
Weather-based crop monitoring sensors: This example involves energy-saving in smart agriculture by using sensors 10 that can be turned AWAKE and SLEEP using weather-based crop monitoring systems. These systems may use sensors 10 to collect data on various weather parameters, such as temperature, humidity, and rainfall.
In the petrochemical industry, it may be required to monitor the level of petrochemicals left in the tank at regular intervals. It can be hazardous for a user to do this monitoring task manually. Thus, sensors 10 may be used for this purpose. These sensors 10 may run on a battery 11, and maintaining battery life of these sensors 10 for a longer duration may be desirable for these and/or other purposes. If these sensors 10 are ON all the time, then they may run out of battery soon. To help avoid this, based on historical data 7, certain example embodiments can predict when a sensor 10 should be turned ON to monitor the petrochemical level in the tank. The remaining time, the sensor 10 can be in SLEEP state. This mechanism may help to run a battery 11 for longer duration and avoid interventions by a user.

A system according to certain example embodiments may be configured as a centralized platform. Decision or deviation pattern detection may happen inside the centralized platform. As it is a centralized system, any sensor 10 may be connected to and particularly onboarded over this system to have the sensors monitored for energy saving.

A system according to certain example embodiments may implement a detection of deviation patterns in historical readings to take a decision. For example, if there may not be much deviation detected in the historical data pattern over a period of time during certain timeframes, then sensor readings may not be much useful for any analysis/decision making.

Therefore, a system according to certain example embodiments may set the sensor to SLEEP mode over such timeframes.

A system according to certain example embodiments may comprise continuous learning and optimization of the interval pattern and thereby overall energy saving. The more data that is present in the system, the better the decision making may be. As the system may be designed to take a decision based on a deviation pattern of historical data, over time as more data gets accumulated in the system the accuracy may improve continuously. For example, if the system may be integrated into an application, in the beginning with less data in the system, the system may turn the sensor to awake/sleep less frequently as the decision making may be based on a minimal amount of data in the system. However, as the system receives more data over a time, the system may have a variety of data points and the system may turn the sensor 10 to awake/sleep more frequently.

A system according to certain example embodiments may concern saving the energy of an underlying sensor unit itself rather than the coordinator node/end appliances. With this the battery life of sensors 10 may be saved. Because when the sensors 10 are being used in remote area, it may be hard to change the sensor battery frequently. As a system according to certain example embodiments may increase the sensor battery itself, it may be a great value addition to such ecosystems.

Certain example embodiments may allow for a combined better decision with easy integration of external systems. An external application that may help in better decision making that can be easily integrated into the systems of certain example embodiments. For example, in a system where temperature readings are measured continuously, integrating a rain/weather forecasting external systems may help in better combined decision making when to put the sensor in AWAKE/SLEEP mode.

In the following, a more detailed description of a system according to certain example embodiments is provided with regard to how the system predicts when sensor should be AWAKE/SLEEP and enables saving sensor energy. The two modes or settings can be defined as:
SLEEP: May be an intermediatory state (battery saver mode) where a sensor 10 can receive commands from the platform, but the sensor 10 cannot transmit data/measurements to the platform.

AWAKE: May be an ON state where the sensor 10 can receive commands from the platform as well as transmit data and/or measurements back to the platform.

As data from sensors 10 may be time-series data, there could be many other ways/approaches to pick the samples and calculate standard deviation. An example would be to get a standard deviation for every hour data vertically (Naive forecasting). According to certain example embodiments, the method as described below is used, which may be designated as Mean Forecasting approach.

According to a first step, it may be assumed that there is a sensor 10 deployed in the field. This sensor 10 may have emitted the data continuously as below. For example, with respect to the oceanography example described above, moorings may be deployed under the deep sea. They may usually be attached to the bottom of a ship. Moorings in this example are embedded with various sensors to measure underneath currents, temperature, salinity, etc. The following table may represent temperature data received from a temperature sensor 10 over a period, wherein the temperature is indicated as ° C.

| 1 day ago | 1 week ago | 1 month ago | 1 year ago |
|---|---|---|---|
| 10:00 AM->30 | 10:00 AM >30.2 | 10:00 AM->30.2 | 10:00 AM->30 |
| 10:05 AM->30 | 10:05 AM->30.2 | 10:05 AM->30.2 | 10:05 AM->30 |
| 10:10 AM->30.1 | 10:10 AM->30.1 | 10:10 AM->30.1 | 10:10 AM->30.1 |
| 10:15 AM->30 | 10:15 AM->30.2 | 10:15 AM->30.15 | 10:15 AM->30 |
| . . . | . . . | . . . | . . . |
| . . . | . . . | . . . | . . . |
| 11:00 AM->30.1 | 11:00 AM->30.2 | 11:00 AM->30.3 | 11:00 AM->30.3 |
| 11:05 AM->30.1 | 11:05 AM->30.15 | 11:05 AM->30.25 | 11:05 AM->30.2 |
| 11:10 AM->30.1 | 11:10 AM->30.2 | 11:10 AM->30.3 | 11:10 AM->30.3 |
| 11:15 AM->30.15 | 11:15 AM->30.2 | 11:15 AM->30.35 | 11:15 AM->30.3 |
| . . . | . . . | . . . | . . . |
| . . . | . . . | . . . | . . . |
| 12:00 PM->30 | 12:00 PM->30.2 | 12:00 PM->30.3 | 12:00 PM->30.2 |
| 12:05 PM->30.05 | 12:05 PM->30.25 | 12:05 PM->30.3 | 12:05 PM->30.2 |
| 12:10 PM->30.05 | 12:10 PM->30.2 | 12:10 PM->30.25 | 12:10 PM->30.25 |
| . . . | . . . | . . . | . . . |
| . . . | . . . | . . . | . . . |
| 13:00 PM->31 | 13:00 PM->31.2 | 13:00 PM->31.3 | 13:00 PM->31.2 |
| 13:05 PM->31 | 13:05 PM->31.2 | 13:05 PM->31.3 | 13:05 PM->31.25 |
| 13:05 PM->31.5 | 13:05 PM->31.25 | 13:05 PM->31.3 | 13:05 PM->31.25 |
| . . . | . . . | . . . | . . . |
| . . . | . . . | . . . | . . . |
| and so on | and so on | and so on | and so on |

Initially a temperature sensor 10 attached to a mooring may be ON (AWAKE) all the time. The sensor 10 may send the data continuously with an interval of time.

These data are recorded in the system and may be considered to be historical data 7 in the next steps described hereinafter. These numerical data are may be stored in a backend against time instances and hence these sensor readings may basically be timeseries data.

An Energy Management System (EMS) may use all the historical readings of the sensor 10 for deciding. To explain how the EMS according to certain example embodiments is designed, for simplicity, only major time instances may be considered as in step 2. In the example below, a few sample time data may have been taken. A model may be built with all the historical data of a sensor 10. Initially a prediction model may be trained with less data. When new data is received from sensors, the new data may be fed to the prediction model for retraining.

According to a second step, data may be taken out for a few sample time instances as in the table below, wherein the temperature is indicated as ° C.:

| | Last | Last | Last | Last |
|---|---|---|---|---|
| | Day | Week | Month | Year |
| t1 | 30 | 30.2 | 30.2 | 30 |
| (10:00 AM) | | | | |
| t2 | 30.1 | 30.2 | 30.3 | 30.3 |
| (11:00 AM) | | | | |
| t3 | 30 | 30.2 | 30.3 | 30.2 |
| (12:00 PM) | | | | |
| t4 | 31 | 31.2 | 31.3 | 31.2 |
| (13:00 PM) | | | | |

If for any time instance, sensor readings are not available for Last Day/Week/Month/Year, then such values may be ignored.

According to a third step, the average of all the values at each time instances may be calculated:
t1avg−30.1° C.
t2avg−30.23° C.
t3avg−30.2° C.
t4avg−31.18° C.

According to a fourth step, a calculation of the standard deviation of the above readings may be provided.

$$s = \sqrt{\frac{{Σ ( X - \overline{x} )}^{2}}{n - 1}}$$

where s is the sample standard deviation, Σ represents the sum of, X stands for each value, x̅ is the sample mean, and n is the number of values in the sample.

For the above set of data, the standard deviation may be SD=0.437 (˜0.44).

According to a fifth step, predictions may be determined. According to an exemplarily first case, a situation is considered when there is no external abstraction predicted by the system.

The system according to certain example embodiments may predict the state of the sensor 10 based on its historical data as below:

| Time | Sensor | Sensor | |
|---|---|---|---|
| Instances | Current Status | Next Status | Comments |
| t1 | AWAKE | SLEEP | Since not much deviation |
| | (Initial status) | (t2avg − | happened historically |
| | | t1avg < SD) | at t2, the model may |
| | | | predict sensor status |
| | | | to be SLEEP after t1 |
| t2 | SLEEP | SLEEP | Since not much deviation |
| | | (t3avg − | happened historically |
| | | t2avg < SD) | at t3, the model may |
| | | | predict sensor status |
| | | | to be SLEEP after t2 |
| t3 | SLEEP | AWAKE | Since sensor readings |
| | | (t4avg − | deviated more at t4, |
| | | t3avg > SD) | the model may predict |
| | | | sensor status to be |
| | | | AWAKE before t4 |
| t4 | AWAKE | . . . and so on | |

It may be seen that the system according to certain example embodiments may be effectively predicting a sensor status based on historical readings and, thus, may enable energy saving. The sensor may automatically switch on again after a certain amount of time or depending on the battery life.

According to certain example embodiments, the EMS System may be integrated with an external system for predicting based on external environmental changes.

For instance, in this example embodiment, it may be a sunny day and there may be no changes in the temperature sensor 10 (which may be embedded in the mooring) readings in the past. A standard deviation rule in EMS may have given a decision to keep the temperature sensor OFF. Suddenly, an external model (e.g., a model integrated with an EMS system) may predict that it is going to rain.

In this situation, even if the standard deviation rule may not indicate much deviation in the past for a particular time frame, the energy management system may ask the IoT app to turn to AWAKE the temperature sensor 10 as there are external environmental changes predicted. Otherwise, sensor 10 may be still in the SLEEP state thus saving the energy and particularly making sure the QoS is good.

In the oceanography example, the temperature sensor 10 may be considered. In Case 1, the energy management system (EMS) according to certain example embodiments may have predicted the sensor to be in the OFF state. Now, a weather forecasting model, which may be integrated as a part of the EMS, may predict that it is going to rain by next time instance. In such a case, even if the first case failed (standard deviation), the EMS may signal the IoT app to turn on the temperature sensor because of weather forecasting.

Furthermore, a system according to certain example embodiments of the invention may comprise a low battery 11 indicator. In terms of battery life-if the sensor device is warrantied for X messages. There may be a value in the payload, “mid” which may be a representation of how many messages have been sent since the battery was connected, so one may monitor this to give an indication on battery health.

$$usage = [ P V ( mid ) * 100 ] / X$$

usage=Battery used in %
PV (mid)=Present value of mid (total number of messages send till current time)
X=total messages sensor device is warrantied for

$$\% b = 100 - usage$$

$$\% b = Battery status / health used in \% ( remaining battery life in \% )$$

Battery health may have a direct correlation with environmental factors like outside temperature, so it may be very much required to maintain sensor operational temperature, else erratic battery performance may occur or faster than expected battery depletion. When low % b is detected then the system may alert the user.

The sensor state in a sensor mesh 10 which is connected to an IoT application 6 may deliver data in an energy efficient way by means of the Energy Efficiency Model 5, for example, which may predict when sensor data needs to be fetched/when to put a sensor in an AWAKE state based on predictions and factors (involves environmental factors like temperature, deviation, battery health etc.) (cf. FIG. 3), etc.

In the sample data that have been taken to explain the concept, one may conclude how the model according to certain example embodiments may use historical data to predict the sensor_next_state. The model may implement time series forecasting and also use incoming new sensor data to adjust standard deviation continuously. This may provide an outcome in which QoS is improved. And, as explained above, the model may be retrained on arrival of a new data set or new data. This may make sure that the prediction model is better trained for better QoS.

Furthermore, a system according to certain example embodiments may make a determination as to when the sensor 10 is to be switched off. Broadly speaking, the amount of change in measured data may be evaluated. For example, standard deviation may be used as a measure, but any other deviation measure may be acceptable, as well.

According to certain example embodiments, consecutive measurements may be provided. If the amount of change (e.g., standard deviation or any other measure) over the last X measurements or during the last X time unit (e.g., during the last hour) is below a predetermined value (e.g., calculated standard deviation <predetermined standard deviation), then the sensor 10 is preferably switched off.

According to certain example embodiments, the amount of change may always be measured at a specific time point (e.g., every day at 10:00), as per the calculation described above. In this case, the measurements that are taken into account to calculate the amount of change do not necessarily have to be from a day/week/month ago—it is also possible that the values are taken on consecutive days or picked according to any other pattern for that specific time point. A difference may not be calculated (e.g., t2avg-t1avg<SD). Instead, it may be checked whether the amount of change is below a predetermined value (i.e., calculated standard deviation at 10:00<predetermined standard deviation). It is possible that for different timepoints or timeframes, there are different predetermined standard deviations.

Also, battery health may be taken into account to switch off sensors 10. For instance, a condition for switching the sensor 10 off may be formulated as follows: (measured standard deviation+f (battery health)<predetermined standard deviation). In this case, by means of function f, a specific value is derived from the battery health—and if the battery health is low, the device may switch off more easily.

Furthermore, the measured value itself may also be taken into account to switch off the sensor 10 (e.g., have a higher tendency to switch off sensor 10 at higher temperatures).

There could be specific triggers for switching the device or the sensor 10 on again. For instance, the device or the sensor 10 could be switched on again depending on any external event (input from another sensor 10, user input, etc.). However, there could also be time-based triggers for switching the device or the sensor 10 on again. The device or the sensor 10 could be switched off for a specific amount of time always (constant value). Alternatively, the length of the time frame may depend on the amount of change (e.g., standard deviation). According to certain example embodiments, the amount of time that a sensor 10 will be switched off may depend both on the amount of change and the amount of battery power left. According to certain example embodiments, the amount of time that a sensor 10 will be switched off may depend on the specific timepoint at which the sensor 10 is switched off. According to certain example embodiments, the amount of time that a sensor 10 will be switched off may dependin on the specific sensor value measured (e.g., switch off longer at higher temperatures).

According to certain example embodiments, the sensor 10 is not switched on or off. Instead, the rate at which measurements are made is modified. High amount of change may lead to a high rate of measurements taken; low amount of change may lead to a low rate of measurements. This rate may be influenced by the factors mentioned before, e.g. amount of change (standard deviation or the like), input from other sensors 10, battery state, current time, and the value which has been actually measured.

The following is pseudocode that may tell when a sensor 10 should be AWAKE/SLEEP.

```
SET LOW_SENSOR_BATTERY_ALERT=SLEEP
  WHILE TRUE
    SET SENSOR_AWAKE=false
    WHEN ENV_CHANGES_PREDICTED for Tnext {
      SET SENSOR_ON=true
    }
    WHEN Svalue_next−Svalue_current > SD then {
      SET SENSOR_AWAKE=true
    }
    WHEN %Bvalue < Threshold then {
      SET LOW_SENSOR_BATTERY_ALERT=ON
    }
  END
```

With respect to this example pseudocode:
ENV_CHANGES_PREDICTED: This prediction may happen by a model which is designed offline.
Svalue_next: This may indicate what was the historical sensor reading on next time interval.
Svalue_current: This may indicate what the historical sensor reading was on a current time interval.
SD: This may indicate a standard deviation calculated for historical readings.
% Bvalue: This may indicate a remaining battery life.
Threshold: This may indicate a battery functional percentile below which alert may be notified.

FIG. 4 is a flowchart for an Energy Management System in accordance with certain example embodiments.

The uppermost box in FIG. 4 designates a start (111). According to the embodiment of FIG. 4, the sensor 10 may send sensor data to a platform 112, which may result in time series data in a database 113. In step 114, a deviation pattern may be evaluated. Based on the deviation pattern, at least one rule 115 may be applied. If an output of the application of the rule 115 is true 118, then the sensor 10 may be set to an awake state 117 and may afterwards be continuously evaluated 120. If the output of the application of the rule 115 is false 119, then the sensor 10 may be set to a sleep state 116 and may afterwards be continuously evaluated 120.

The foregoing explanation describes the present invention in the context of certain example embodiments. Of course, individual features of the embodiments can be freely combined with each other, provided that this is technically reasonable, without leaving the scope of the present invention.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A computer-implemented method for managing energy of at least one sensor, the method comprising:
collecting sensor data resulting from a detection by the at least one sensor, the sensor data comprising sensor values specific to a characteristic to be detected by the at least one sensor;
evaluating the collected sensor data, the evaluating comprising generating an operating specification for the at least one sensor based on a detection of at least one deviation pattern in the sensor values of the collected sensor data that indicates a variation of the characteristic to be detected, the operating specification defining a future activity pattern for the detection by the at least one sensor; and
initiating at least one change of an operational setting for the detection by the at least one sensor, the change being initiated based on the generated operating specification.

2. The method according to claim 1, wherein the generating is based on the detection of the at least one deviation pattern in the sensor values of the collected sensor data, the sensor values being measured values that represent a quantification of the characteristic to be detected, the characteristic being a measurand.

3. The method according to claim 1, wherein the generating of the operating specification for the at least one sensor is further based on: a detection time indicating a time of detection or transmission of the sensor values by the least one sensor, a change time indicating a time of change of the sensor values, and/or a deviation indicator that is based on a standard deviation of a series of the sensor values.

4. The method according to claim 1, wherein the evaluating comprises applying at least one rule based on the sensor values of the collected sensor data using a rule-based engine, and
wherein the initiating of the change of the operational setting is based on the applied at least one rule.

5. The method according to claim 4, wherein the at least one rule specifies applying a procedure to derive a standard deviation to detect the at least one deviation pattern in the collected sensor data of the at least one sensor and deciding on the operating specification based on the procedure to derive the standard deviation; and/or applying at least one external environmental monitoring system to predict external changes of an environment of the at least one sensor and deciding on the operating specification based on an output of the at least one external environmental monitoring system.

6. The method according to claim 4, further comprising:
receiving a flag for the at least one sensor, the flag being specific to a sensor type of the at least one sensor; and
carrying out the initiating of the at least one change of the operational setting based on the received flag, to enable the energy management and/or the application of the rules based on the received flag.

7. The method according to claim 1, wherein a continuous learning and optimization of the generating of the operating specification, including the detection of the at least one deviation pattern, is carried out, the continuous learning and optimization comprising:
periodically updating the generated operating specification based on further collected sensor data of the at least one sensor, and
carrying out the evaluating of the further collected sensor data to amend or replace the operating specification based on the sensor values of the further collected sensor data.

8. The method according to claim 1, wherein the operating specification specifies a pattern of the at least one change of the operational setting, the pattern comprising a sequence of changes including different operational settings, and/or states of the operation, of the at least one sensor over time.

9. The method according to claim 1, wherein:
the operational settings include at least one of the following:
a sleep state in which receiving of commands of the at least one sensor is enabled and a transmission of the sensor data from the at least one sensor is disabled, the initiating of the at least one change of the operational setting being carried out by sending at least one of the commands to the at least one sensor,
an awake state in which the receiving of commands and the transmission of the sensor data from the at least one sensor is enabled, and
a rate at which the detection by the at least one sensor takes place, and
the at least one sensor is initially in the awake state for a defined timeframe to provide the collected sensor data for the evaluating.

10. The method of claim 9, wherein the rate is the rate at which sensor values are collected.

11. The method according to claim 1, further comprising:
calculating a mean and a standard deviation of the collected sensor data over a defined time period, and
generating the operating specification for the at least one sensor based on the calculated mean and standard deviation of the collected sensor data.

12. The method according to claim 1, wherein the generating of the operating specification is further based on an external model responsive to external environment monitoring, and/or monitoring of external user operations impacting the at least one sensor.

13. The method of claim 1, further comprising monitoring a battery of the at least one sensor to determine whether the battery has a low battery status, wherein the generating of the operating specification is based on whether the battery has a low battery status.

14. The method according to claim 13, wherein the low battery status is alerted to a user.

15. The method according to claim 1, further comprising changing the operational setting for the detection of the at least one sensor based on at least one trigger, the at least one trigger comprising at least a signal indicating an external event.

16. The method according to claim 15, wherein the external event is a user input, a time event, a defined deviation pattern, and/or a defined timepoint of a low battery status of a battery of the at least one sensor.

17. A system configured to manage energy of at least one sensor, the system comprising:
an interface to the at least one sensor; and
at least one processor and a memory coupled together and configured to perform operations comprising:
collecting sensor data resulting from a detection by the at least one sensor, the sensor data comprising sensor values specific to a characteristic to be detected by the at least one sensor;
evaluating the collected sensor data, the evaluating comprising generating an operating specification for the at least one sensor based on a detection of at least one deviation pattern in the sensor values of the collected sensor data that indicates a variation of the characteristic to be detected, the operating specification defining a future activity pattern for the detection by the at least one sensor;
initiating at least one change of an operational setting for the detection by the at least one sensor, the change being initiated based on the generated operating specification

18. The system of claim 17, wherein the operations further comprise monitoring a battery of the at least one sensor to determine whether the battery has a low battery status, wherein the generating of the operating specification is based on whether the battery has a low battery status.

19. The system according to claim 17, wherein:
the evaluating comprises applying at least one rule based on the sensor values of the collected sensor data using a rule-based engine,
the initiating of the change of the operational setting is based on the applied at least one rule, and
the at least one rule specifies applying a procedure to derive a standard deviation to detect the at least one deviation pattern in the collected sensor data of the at least one sensor and deciding on the operating specification based on the procedure to derive the standard deviation; and/or applying at least one external environmental monitoring system to predict external changes of an environment of the at least one sensor and deciding on the operating specification based on an output of the at least one external environmental monitoring system.

20. The system according to claim 17, wherein:
the evaluating comprises applying at least one rule based on the sensor values of the collected sensor data using a rule-based engine,
the initiating of the change of the operational setting is based on the applied at least one rule, and
the initiating of the at least one change of the operational setting is based on a received flag to enable the energy management and/or the application of the rules based on the received flag, the flag being specific to a sensor type of the at least one sensor.

21. The system according to claim 17, wherein the generating of the operating specification is further based on an external model responsive to external environment monitoring, and/or monitoring of external user operations impacting the at least one sensor.

22. A non-transitory computer readable storage medium tangibly storing instructions that, when executed, cause a computer to perform the method of claim 1.

23. A sensor comprising:
a battery;
an interface to a system configured to manage energy of the sensor;
wherein the sensor is configured to at least:
collect sensor data comprising sensor values specific to a characteristic to be detected by the sensor;
transmit the collected sensor data to the system for an evaluation comprising generating of an operating specification for the sensor based on a detection of at least one deviation pattern in the sensor values of the collected sensor data that indicates a variation of the characteristic to be detected, the operating specification defining a future activity pattern for the detection by the sensor; and
change an operational setting for detection by the sensor, the change being initiated based on the generated operating specification, and being received from the system by the sensor.

24. The sensor according to claim 23, wherein:
the battery of the sensor is monitored by the system to determine whether the battery has a low battery status, and
the generating of the operating specification is based on whether the battery has a low battery status.
